(19) United States
(12) Patent Application Publication
(10) Pub. No.: US 2025/0139613 A1
(43) Pub. Date: May 1, 2025

(54) MANAGING SECURE COMMUNICATIONS WITH CONFIDENTIAL ENTITIES

(71) Applicant: R3 Ltd., London (GB)

(72) Inventors: Sotiria FYTRAKI, London (GB); Matthew NESBIT, London (GB)

(21) Appl. No.: 18/927,457

(22) Filed: Oct. 25, 2024

Related U.S. Application Data
(60) Provisional application No. 63/593,930, filed on Oct. 27, 2023.

(51) Int. Cl. G06Q 20/38; G06Q 20/36

(52) U.S. Cl. CPC G06Q 20/3825; G06Q 20/36

(57) ABSTRACT

Central bank digital currency (CBDC) tokens are used for payment in a transaction initiated by a payment card at an acquirer's point of sale. To facilitate these transactions, a payer node in a distributed ledger environment receives communication metadata that includes a communication value and a communication key from a payment device. The payer node can generate a communication structure that includes indications of input tokens to be spent in the transaction, as well as an output token associated with the communication key. The payer node can transmit the communication structure to a second node for verification of the signature and subsequent validation of the transaction.

### PRIORITY CLAIM

This application claims the benefit of U.S. Patent Application No. 63/593,930, filed Oct. 27, 2023, and titled “MANAGING SECURE COMMUNICATIONS WITH CONFIDENTIAL ENTITIES,” which is incorporated herein by reference in its entirety.

### RELATED APPLICATIONS

This application hereby incorporates by reference U.S. Provisional Patent Application 63/439,055, filed on Jan. 13, 2023, titled “Card Payments using CBDC Tokens,” and by inventors Stefan Iliev et al. in its entirety, and U.S. Non-provisional application Ser. No. 18/347,513, filed on Jul. 5, 2023, titled “Secure Processing of Central Bank Digital Currency (CBDC) Card Payments” in its entirety.

### BACKGROUND

The bitcoin system was developed to allow electronic cash to be transferred directly from one party to another without going through a financial institution, as described in the white paper entitled “Bitcoin: A Peer-to-Peer Electronic Cash System” by Satoshi Nakamoto. A bitcoin (e.g., an electronic coin) is represented by a chain of transactions that transfers ownership from one party to another party. To transfer ownership of a bitcoin, a new transaction is generated and added to a stack of transactions in a block. The new transaction, which includes the public key of the new owner, is digitally signed by the owner with the owner's private key to transfer ownership to the new owner as represented by the new owner public key. Once the block is full, the block is “capped” with a block header that is a hash digest of all the transaction identifiers within the block. The block header is recorded as the first transaction in the next block in the chain, creating a mathematical hierarchy called a “blockchain.” To verify the current owner, the blockchain of transactions can be followed to verify transactions, from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

To ensure that a previous owner of a bitcoin did not double-spend the bitcoin (i.e., transfer ownership of the same bitcoin to two parties), the bitcoin system maintains a distributed ledger of transactions. With the distributed ledger, a ledger of all the transactions for a bitcoin is stored redundantly at multiple nodes (i.e., computers) of a blockchain network. The ledger at each node in a particular set or subset of nodes is stored as a blockchain. In a blockchain, the transactions are stored in the order that the transactions are received by the nodes. A particular node in the blockchain network can have a complete replica of the entire blockchain. The bitcoin system also implements techniques to ensure that nodes will store the identical blockchain, even though nodes may receive transactions in different orderings. To verify that the transactions in a ledger stored at a node are correct, the blocks in the blockchain can be accessed from oldest to newest, generating a new hash of the block and comparing the new hash to the hash generated when the block was created. If the hashes are the same, then the transactions in the block are verified. The bitcoin system also implements techniques to ensure that it would be infeasible to change a transaction and regenerate the blockchain by employing a computationally expensive technique to generate a nonce that is added to the block when it is created. A bitcoin ledger is sometimes referred to as an Unspent Transaction Output (UXTO) set because it tracks the output of all transactions that have not yet been spent.

Although the bitcoin system has been very successful, it is limited to transactions in bitcoins or other cryptocurrencies. Efforts are currently underway to use blockchains to support transactions of any type, such as those relating to the sale of vehicles, sale of financial derivatives, sale of stock, payments on contracts, and so on. Such transactions use identity tokens, which are also referred to as digital bearer bonds, to uniquely identify something that can be owned or can own other things. An identity token for a physical or digital asset is generated using a cryptographic one-way hash of information that uniquely identifies the asset. Tokens also have an owner that uses an additional public/private key pair. The owner public key is set as the token owner identity and when performing actions against tokens, ownership proof is established by providing a signature generated by the owner private key and validated against the public key listed as the owner of the token. A person can be uniquely identified, for example, using a combination of a username, social security number, and biometric (e.g., fingerprint). A product (e.g., refrigerator) can be uniquely identified, for example, using the name of its manufacturer and its serial number. The identity tokens for each would be a cryptographic one-way hash of such combinations. The identity token for an entity (e.g., person or company) may be the public key of a public/private key pair, where the private key is held by the entity. Identity tokens can be used to identify people, institutions, commodities, contracts, computer code, equities, derivatives, bonds, insurance policies, loans, documents, and so on. Identity tokens can also be used to identify collections of assets. An identity token for a collection may be a cryptographic one-way hash of the digital tokens of the assets in the collection. The creation of an identity token for an asset in a blockchain establishes provenance of the asset, and the identity token can be used in transactions (e.g., buying, selling, insuring) involving the asset stored in a blockchain, creating a full audit trail of the transactions.

To record a simple transaction in a blockchain, the parties and assets involved with the transaction needs an account that is identified by a digital token. For example, when one person wants to transfer a car to another person, the current owner and the next owner create accounts, and the current owner also creates an account that is uniquely identified by its vehicle identification number. The account for the car identifies the current owner. The current owner creates a transaction against the account for the car that indicates that the transaction is a transfer of ownership, indicates the public keys (i.e., identity tokens) of the current owner and the next owner, and indicates the identity token of the car. The transaction is signed by the private key of the current owner and the transaction is evidence that the next owner is now the current owner.

To enable more complex transactions than bitcoin can support, some systems use “smart contracts.” A smart contract is computer code that implements transactions of a contract. The computer code may be executed in a secure platform (e.g., an Ethereum platform, which provides a virtual machine) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes, initializing the smart contract and its state. The state of a smart contract is stored persistently in the blockchain. When a transaction is recorded against a smart contract, a message is sent to the smart contract, and the computer code of the smart contract executes to implement the transaction (e.g., debit a certain amount from the balance of an account). The computer code ensures that all the terms of the contract are complied with before the transaction is recorded in the blockchain. For example, a smart contract may support the sale of an asset. The inputs to a smart contract to sell a car may be the identity tokens of the seller, the buyer, and the car and the sale price in U.S. dollars. The computer code ensures that the seller is the current owner of the car, and that the buyer has sufficient funds in their account. The computer code then records a transaction that transfers the ownership of the car to the buyer and a transaction that transfers the sale price from the buyer's account to the seller's account. If the seller's account is in U.S. dollars and the buyer's account is in Canadian dollars, the computer code may retrieve a currency exchange rate, determine how many Canadian dollars the seller's account should be debited, and record the exchange rate. If either transaction is not successful, neither transaction is recorded.

When a message is sent to a smart contract to record a transaction, the message is sent to each node in a particular set or subset of nodes that maintain a replica of the blockchain. Each node executes the computer code of the smart contract to implement the transaction. For example, if 100 nodes each maintain a replica of a blockchain, then the computer code can execute at each, most, or a predetermined consensus quantity of the 100 nodes. When a node completes execution of the computer code, the result of the transaction is recorded in the blockchain. The nodes employ a consensus algorithm to decide which transactions to keep and which transactions to discard. Although the execution of the computer code at each node helps ensure the authenticity of the blockchain, large amounts of computer resources can be expended to support such redundant execution of computer code.

The term “contract” has been used to describe the computer code of a contract under the UXTO model of bitcoin and the computer code of the “smart contracts” model of the Ethereum platform. The “contracts” under these models are, however, different. In the UXTO model, the distributed ledger is a set of immutable rows keyed by (hash: output index) values. The “hash” is a hash of the transaction that generated the output represented by the row, and the “output index” identifies which one of the possibly many outputs of the transaction that the row represents. A UXTO contract is deterministic and performs no processing other than validating the inputs to the transaction. In the “smart contract” model, the computer code of the smart contract is an instantiation of the computer code that is maintained by every node that stores the blockchain. A “smart contract” can perform virtually any type of processing such as receiving messages, sending messages, accessing external databases, and so on.

### BRIEF DESCRIPTION OF THE DRAWINGS

Detailed descriptions of implementations of the present invention will be described and explained through the use of the accompanying drawings.

FIG. 1 is a diagram that illustrates an example of a transaction in some embodiments.

FIG. 2 is a diagram that illustrates a communication system for management of communications, in accordance with one or more embodiments.

FIG. 3 is a diagram that illustrates a process for generating a communication request and digital signatures associated with input tokens, in accordance with one or more embodiments.

FIG. 4 is a diagram that illustrates input and output communication tokens, as well as associated communication values, in accordance with one or more embodiments.

FIG. 5 is a diagram that illustrates communication validation on the basis of the verification of digital signatures, in accordance with one or more embodiments.

FIG. 6 is a flowchart that describes generation of a communication structure for execution of a communication, in accordance with one or more embodiments.

FIG. 7 is a flowchart that describes communication key creation and subsequent communication validation, in accordance with one or more embodiments.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

A central bank digital currency (CBDC) is a type of digital currency that is equivalent to a country's fiat currency. Although CBDCs carry the value of fiat currency, it is currently difficult to use CBDCs as payment for good or services because existing consumer payment infrastructure does not support token-based transactions. Furthermore, conventional consumer payment infrastructure (e.g., traditional point-of-sale systems) can involve multiple stages of authentication, such as authorization, clearing, and settlement phases, prior to successful transfer of currency for goods and services, thereby delaying settlement of the transactions. Such consumer payment infrastructure generally includes information identifying parties of the transaction, including account numbers, transaction values, and/or merchant/customer identification values. As such, conventional transaction systems do not enable anonymity or privacy with respect to details associated with transactions.

In existing token-based cryptographic communication systems, hierarchical deterministic keychains provide a way to generate private keys (and corresponding public keys) associated with a single parent key, thereby providing an extra level of anonymity in transactions. However, such hierarchical deterministic keychains are based on security information (e.g., secrets, keys) that are included within the corresponding blockchain, which potentially exposes the derived security information (e.g., child keys) to identification using the stored security information (e.g., the parent secret).

Furthermore, another technical problem is that in transaction systems where transactions are generated with such hierarchical deterministic keys and are verified later, scalability is a problem. The child keys must be stored in a database, which can grow monotonically over time to accommodate further keys associated with further transactions.

Thus, inventors recognize that conventional token-based transaction systems stand to benefit from more robust anonymity and security, as well as improved scalability.

To solve these problems with conventional systems, such as point-of-sale systems or cryptography-based token transfer systems, the systems and methods described herein enable virtually instant settlement of transactions, while protecting the anonymity of participating entities. For example, a merchant device can generate a public/private key pair associated with a given transaction by using a secret and/or nonce. As used herein, the term “secret” refers to an item or set of items that can be used in cryptographic systems to generate keys, authenticate users, and encrypt data. Examples of a secret include a password or passphrase, private key, security token, biometric data, or a combination thereof. The term “nonce” (short for “number used only once,” or “number used once”) refers to an item or set of items that can include one or more of a random or pseudo-random value used as part of a particular authentication protocol to ensure that a particular transaction is unique, allowable, validated, verified, or authenticated. Nonce data elements can include, but are not limited to, an associated time value indicative of when the nonce was generated, a sequential number associated with the transaction, a unique identifier value, and/or a hash value.

A cryptographic nonce can be employed to protect against attempts to attack, tamper, or forge blocks/block data (e.g., replay attacks) by producing a unique value for a particular session or transaction. A session refers to a specific period during which an interaction or transaction (or series of interactions/transactions) occurs. In some use cases, a nonce is a variable or a set of variables manipulated to produce a hash value that satisfies particular rules. The nonce can be changed multiple times or continually until a hash is produced that satisfies a set of particular properties. Satisfying these particular properties can include satisfying a predetermined level of difficulty or meeting a set difficulty target. A cryptographic hash function nonce can also be used in a hashing algorithm—for example, to alter the input nonce and the output hash. Examples of hash algorithms that can be used include the use of rolling or recursive hashing, perceptual hashing, radix conversion hashing, cyclic redundancy checks, checksum functions, and cryptographic hash functions (e.g., MD5, SHA1, SHA-256, REPEMD-160, Keccak-256/Ethash, X11, Scrypt, BLAKE, Tiger, Groestl, Lyra2rev2).

The merchant device can provide the corresponding public key to a customer device, as well as information relating to the nature of the transaction, such as a requested payment value. In turn, the customer device can transmit this information to a corresponding node (e.g., a server or virtual node [vnode]). The customer's vnode can generate a transaction based on identifying tokens with a value exceeding the requested payment value; these tokens may be signed utilizing a nonce associated with generation of the corresponding token. Having identified these tokens, the customer's vnode can generate output tokens for satisfaction of the requested payment to the merchant's vnode. For example, at least one output token may be associated with a nonce that represents the public key associated with the given transaction, thereby providing access to the token to the merchant's device and/or vnode. The merchant's vnode can sign the transaction using the private key associated with the given transaction, as generated previously, and transmit the signed transaction to the merchant's device (e.g., a point-of-sale system) for verification of transaction completion.

As such, the disclosed systems enable instant verification of transactions based on generation of payment tokens and immediate verification of such payment tokens. For example, by generating a new public/private key pair for a transaction, and by storing a secret or key associated with this key pair off-ledger (e.g., in a data structure that is not stored within a distributed ledger of the payment system), the merchant vnode enables anonymization of the transaction by preventing exposure of the secret to other users of the associated ledger. Moreover, verification of the transaction may be carried out instantaneously following generation of the transaction by the customer's vnode and subsequent transmission of the transaction to the merchant's vnode and/or device. Thus, the system disclosed herein provides immediate transaction settlement, while preserving the anonymity of associated entities.

Anonymous Payment System with Instant Settlement

The system and methods described herein enable anonymous transactions based on tokens (e.g., token states) controlled by corresponding users, where such transactions may be settled instantaneously. For example, the system can provide confidential identities to merchants or customers (e.g., payees or payers, respectively), where such confidential identities are generated for transactions based on a secret or keyword stored off-ledger. As such, subsequent transactions cannot be traced to the merchant or customer, thereby improving the security of the system. Furthermore, a particular token state can store a nonce used to generate a public/private key pair associated with the state; as such, such information relating to the owner of each token need not be stored in an additional database table. In one such embodiment, the token state includes a nonce and a corresponding public/private key pair generated using the nonce.

The disclosed system enables transactions based on wallets that are synchronized with and/or communicably coupled to corresponding nodes. However, the identity of the wallet can be hidden from other users of the system's ledger. For example, the wallet may include a secret that is used to generate confidential identities for a particular transaction and/or token, as well as any unspent tokens associated with the given user. Such tokens may be backed up on the wallet's corresponding node, thereby improving the robustness and consistency of information across the payment system. A user associated with a given wallet retains control over which tokens are to be moved in a transaction. The given wallet can receive tokens during a transaction, or where fiat money (e.g., conventional currencies) are exchanged with such tokens (e.g., CBDC tokens).

By connecting such wallets to corresponding nodes within the payment system, a user who has lost access to the wallet (and, therefore, control of associated tokens) may revive such access with provision of the associated secret to a node, where information relating to the unspent tokens may be stored in a vault. As such, the system disclosed herein improves the robustness and retrievability of resources (e.g., tokens and associated monetary values). Furthermore, due to the modular nature of the wallet associated with the node, the wallet can be moved to other banks or payment systems on the same ledger. In some embodiments, in such a situation, the original bank associated with the wallet provides backchains associated with the wallet's transactions if the transaction history is desired. The wallet, nodes, and transaction flows are described in greater detail below.

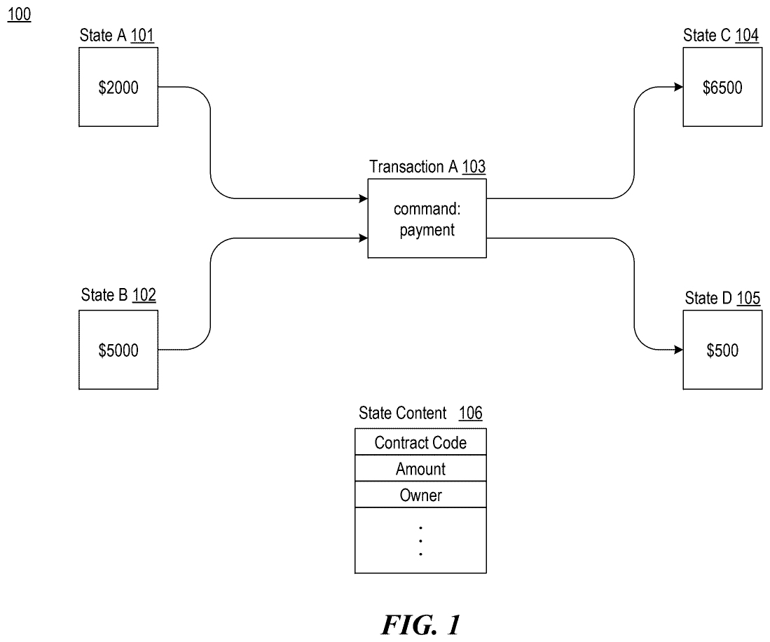

FIG. 1 is a diagram that illustrates an example 100 of a transaction in some embodiments. Transaction A 103 is proposed to make both a payment for goods and services and an associated fee payment (e.g., for a retail bank fee associated with the payment infrastructure). Transaction A specifies the input states of input state A 101 and input state B 102. The input state A specifies that the owner has $2000, and the input state B specifies that the owner has $5000. Transaction A specifies the output states of output state C 104 and output state D 105. The output state C specifies to make a payment to the merchant of $6500, and the output state D specifies to make a fee payment of $500 to a corresponding retail bank associated with the transaction system. State content 106 illustrates example content of a state. To generate transaction A, the paying party (e.g., a customer device and/or node) executes a protocol flow for the transaction. The protocol flow generates transaction A, which specifies the input states and the output states. The output states may identify the accepting (or acceptor) parties for accepting the payment and the fee payment, and may be signed with or associated with a public key related to a nonce associated with the particular transaction A. The paying party may sign each input state (e.g., states A 101 and B 102) with a key associated with a corresponding nonce that is specific to the given input state. The protocol flow then transmits transaction A, including the signed input states and the output states, to the accepting parties. The accepting parties may sign transaction A with the private key associated with the transaction A and send the signed transaction A to devices associated with the accepting parties for further verification. For example, a particular accepting party verifies that transaction A has been signed by the key associated with transaction A and invokes the contract code of the input states and the output states to ensure that the proposed transaction complies with the terms of the contract. Further detail associated with generation of the public/private key pair associated with the transaction, as well as verification, is provided below.

In some implementations, the system may resolve requested communications, including transactions. For example, a communication may include messages, tokens, or other types of information transmitted from at least one party to at least another party. As an illustrative example, a communication may include a transaction, where a first entity pays a second entity in exchange for goods or services. For example, a transaction may include provision of control of a token (e.g., a state) that is associated with a monetary value from the first entity to the second entity. As an illustrative example of the transaction system above, a customer of a coffee shop may order a cup of coffee. In response, a device associated with the merchant (e.g., a point-of-sale system) generates information relating to the transaction, including a monetary value for the cup of coffee and a generated public key associated with this specific transaction (e.g., a coffee purchase). In some implementations, further information is generated relating to the merchant's wallet identifier and corresponding vnode. The merchant device can present this information in the form of a Quick Response (QR) code (or other similar medium), which can be received at the customer's device through its image capture. In response, the customer can select cryptographic tokens (e.g., CBDC tokens) of which the customer has control for payment in exchange for the cup of coffee, as well as payment of any fees associated with the payment system (e.g., to the retail bank). The systems and methods presented herein enable anonymous and instantaneous settlement of the transaction based on this transaction-specific public key.

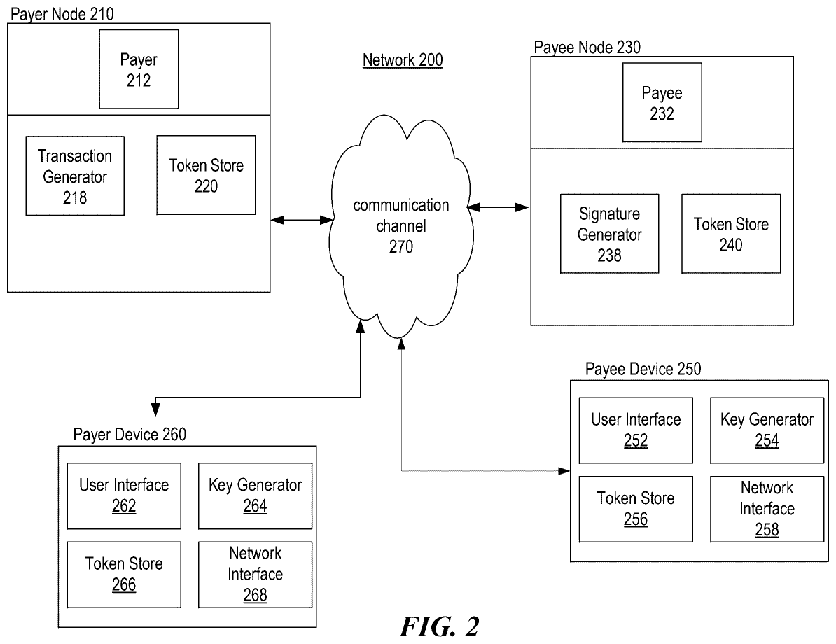

FIG. 2 is a diagram that illustrates a communication system for management of communications, in accordance with one or more embodiments. For example, the communication system can be implemented by nodes and devices of a network 200. A particular entity (e.g., party to a contract, such as a customer or a merchant) may have one or more nodes registered with the network. FIG. 2 illustrates that the network includes a payer node 210, a payee node 230, a payer device 260, and a payee device 250.

The payer node 210 can be associated with a payer 212 and can generate transaction structures through transaction generator 218. The payer node can store tokens owned or controlled by the payer 212 within a token store 220. In some implementations, a node includes a device, server, or computing system capable of communicating with other devices or nodes within a network (e.g., through the communication channel 270). For example, a node can include a blockchain node or any other node that maintains a ledger of cryptographic transactions between users.

The payer node 210 can be associated with a payer device 260 (e.g., also controlled by the payer 212). The payer device 260 can include a wallet (e.g., a token store 266), which can include any device, structure, or entity that can store information associated with tokens, such as private or public keys associated with the generation of such tokens. In some embodiments, for example, the payer device 260 can include an indication of tokens controlled by the payer 212 within token store 266. The system enables synchronization of the token store 220 and the token store 266 to maintain consistent information relating to the tokens controlled by the payer 212. In some implementations, the token store 220 and/or the token store 266 can include a token storage identifier (e.g., a wallet identifier) associated with the wallet for tracking of the tokens and transactions associated with a given user in an off-ledger database. The payer device 260 can include a user interface 262, a key generator 264, a token store 266, and/or a network interface 268. In some embodiments, the payer device 260 includes a camera and associated processing components, such as for identification and processing of information presented on QR codes by another device, such as the payee device 250. Other devices and/or nodes in the system can include the same or similar functions or modules.

The payer node 210 and/or the payer device 260 can generate a transaction for providing control of tokens of a given monetary value to a payee 232 associated with a payee node 230 and/or a corresponding payee device 250 for the satisfaction of a transaction (e.g., in exchange for goods or services). For example, the payee node 230 can include a signature generator 238 and/or a token store 240. For example, the signature generator 238 can generate signatures associated with a given transaction's public or private key for verification of the transaction at the payee device 250. In some embodiments, the token store 240 can include an indication of tokens controlled by the payee 232.

The payee node 230 can be associated with the payee device 250 (e.g., also controlled by the payee 232). For example, the payee device 250 includes a user interface 252, a key generator 254, a token store 256, and a network interface 258. In some embodiments, the user interface 252 is capable of generating and presenting QR codes for interaction with other devices. As such, the payer device 260 and the payee device 250 can exchange or transmit information without utilization of the communication channel 270. As with the payer device 260, the token store 256 can be synchronized with other token stores, such as the token store 240 associated with the payee node 230, in order to maintain consistency in information relating to tokens, such as which tokens are controlled by which users.

Token stores 220, 240, 266, 256 can include storage of data associated with a token state. Token state data can include, but is not limited to, data related to an amount associated with the token, ownership information, contract information, transaction history, transaction lifecycle, token lifecycle, and/or metadata.

The amount associated with the token can be information related to the current balance of the token, sub-balances, locked funds, available funds or unspent transaction outputs, and pending transactions. Ownership information can encompass data related to current and previous owners of the token (e.g., public keys, digital signatures, ownership history). Contract information can pertain to smart contract details associated with the token including contract terms, conditions, and/or execution status. The token's transaction history can document a record of some or all transactions involving the token, such as timestamps, transaction identifiers, and other information related to other involved parties. Examples of token states in a transaction lifecycle include active, pending, confirmed, completed, and/or rejected. Examples of token states in a token lifecycle include unminted, minted (created and added to the blockchain), issued (associated with an entity), transferrable, locked (e.g. temporarily unavailable for transfer due to contract restrictions), frozen (e.g., permanently unavailable for transfer), burned (destroyed and removed), staked, unstaked, redeemed, expired, and/or revoked. In some implementations, the platform can maintain a list mapping token states to transaction states, such that transaction states can be determined on token states.

Token metadata can include maps which can be used to store and retrieve token state data based on unique keys. Trees, such as radix trees, can be used to store and retrieve token state data. Heaps or queues (LIFO, FIFO) can be used to manage priority-based token state data, such as pending transactions or expiring tokens. Graphs and graph databases and/or graph data structures can be used to represent relationships between tokens, owners, and transactions.

Various actions can take place once the token state is determined. For example, if the token state indicates that a token is valid and unspent, the transaction may be allowed to proceed. This can involve subsequently updating the token state to reflect the new ownership and recording the transaction as part of the token's transaction history. Conversely, if the token state indicates that a token has already been spent or is invalid, the transaction can be disallowed or blocked. A token can also be frozen if certain activities are detected (e.g., multiple failed transaction attempts). In some embodiments, a token can be locked to not be used in any transactions until certain conditions are met. In one such example, a token can be locked until a smart contract condition is fulfilled. If a token is found to be compromised or at risk, a token can be replaced. A payer or payee can be prevented from making further transactions if multiple invalid transactions are indicated by their token states (e.g., locking the payee/payer's wallet or device).

Validation of a token state can occur at various specific entities or nodes within the network. In one example, the payer node can perform an initial validation of the token state before initiating a transaction (e.g., ensuring that the tokens being used are valid and unspent). The payee node can also validate the token state upon receiving the transaction request (e.g., verifying authenticity of the tokens before accepting payment). In another example, intermediary nodes, such as validation nodes or consensus nodes, can perform token state validation as part of the transaction verification process. The transaction verification process can include ensuring that all recorded transactions are legitimate and comply with the network.

The computing systems (e.g., nodes) on which the anonymous payment system may be implemented can include a central processing unit, input devices, output devices (e.g., display devices and speakers), storage devices (e.g., memory and disk drives), network interfaces, graphics processing units, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing systems may include desktop computers, laptops, tablets, e-readers, personal digital assistants, smartphones, gaming devices, servers, and so on. The computing systems may access computer-readable media that include computer-readable storage media and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on it or may be encoded with computer-executable instructions or logic that implements the distributed ledger system. The data transmission media is used for transmitting data via transitory, propagating signals or carrier waves (e.g., electromagnetism) via a wired or wireless connection. The computing systems may include a secure cryptoprocessor as part of a central processing unit for generating and securely storing keys and for encrypting and decrypting data using the keys.

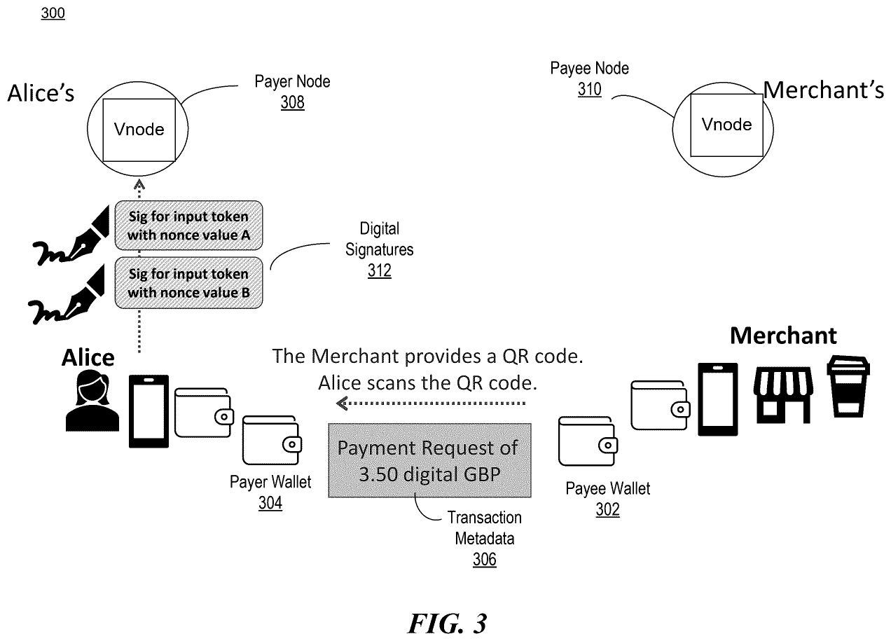

FIG. 3 is a diagram that illustrates a process 300 for generating a communication request and digital signatures associated with input tokens, in accordance with one or more embodiments. For example, in response to a customer requesting a cup of coffee, a device associated with the merchant (e.g., the payee wallet 302) can initiate a communication request, such as a transaction request. The payee wallet 302 can interface with the payee node 310 to generate a public/private key pair associated with the given transaction request, such that the identity of the merchant and the corresponding customer is anonymized for the given transaction. The communication request can include communication metadata, including the transaction metadata 306. Based on the transaction metadata, the payer wallet 304 can select unspent tokens associated with the payer to execute the transaction, where such tokens may be associated with nonces that were used to generate these tokens. In some embodiments, the payer wallet 304 signs the states associated with a particular input token (e.g., a selected token) using their corresponding nonces and transmits these signed input tokens to the payer node 308 associated with the payer wallet 304. By doing so, the payment system enables generation of transaction data for further transfer of cryptographic resources to the merchant and verification of the transaction's completion. Transaction data can include information or parameters associated with a specific transaction. Transaction data can be used to validate, process, and/or record the transaction and can include, but is not limited to, a unique transaction identifier, timestamp, sender/recipient information, transaction amount, nonce value, transaction key, output signature, contract code, and metadata.

A customer can request goods or services from a merchant, such as using a point-of-sale terminal (e.g., the payee device 250). In response to this request, the merchant can generate, through the payee node 310 and/or through the payee wallet 302, a public/private key pair associated with the particular transaction. For example, the payee wallet 302 (e.g., through the key generator 254 associated with the payee device 250) can generate a unique nonce for the new transaction and combine the nonce with a secret associated with the payee wallet 302. The payee wallet 302 can generate the nonce by combining a counter value (e.g., a value that increments by one when a nonce is generated) with a timestamp at generation of the nonce. The payee wallet 302 can utilize an atomic increasing hardware counter for generation of the nonce. Additionally or alternatively, the payment system can generate the nonce using pre-existing identifiers, inputs, or attributes associated with the transaction, such as a timestamp associated with the transaction or a transaction identifier.

Based on the generated nonce, the key generator 254 can generate a public/private key pair based on elliptic-curve cryptography (or any other asymmetric cryptography algorithm, including Rivest-Shamir-Adleman [RSA]-based algorithms), such that this public/private key pair is specific to the current transaction. For example, the public key (e.g., referred to as a communication key or a transaction key) can serve as a unique identifier or reference for the given transaction. In some implementations, the generated key can be symmetric, as in a symmetric-key algorithm. In some embodiments, the generated keys are based on a hash of the nonce, where the hash can include a representation of the nonce as generated by a cryptographic hash function, such as a secure hash algorithm (SHA), a digital signature algorithm (DSA), or any other cryptographic algorithm.

The merchant's wallet (e.g., the payee wallet 302) can store information relating to the transaction, including this public/private key pair, the corresponding wallet identifier, nonce, and/or the secret. The payee wallet 302 can store the amount of the transaction (e.g., the transaction/communication value associated with the purchase). In some embodiments, the public/private key pair, along with the underlying nonce and/or the hash of the nonce, are generated at the node associated with the payee wallet 302 (e.g., the payee node 310). For example, a wallet (e.g., referred to as a token storage, as associated with the payee or the payer) can store these key pairs associated with the given owner of the wallet, including key pairs associated with tokens controlled by the owner. Furthermore, the wallet can store the states (e.g., state references) associated with the tokens, which can include information relating to the token's value, the nonce used to generate the public/private key pair associated with the token, and the corresponding owner. The wallet can build transaction objects, and sign transaction objects using the private keys stored within the wallet.

In some embodiments, a wallet can be associated with more than one device. For example, the payee wallet 302 can be accessible and/or stored on multiple payee devices (e.g., for employees of the merchant). In some implementations, different devices and/or different users may have access to different features of the wallet. For example, a low-level employee may be able to generate transaction requests in response to customer requests for goods or services, while only a manager is allowed to move tokens to other systems (e.g., to a commercial bank account, to employee's bank accounts, or to a supplier). Alternatively or additionally, a single user (and/or associated device) can access multiple wallets, such as those associated with multiple accounts (e.g., an employee wallet and a personal wallet).

The merchant wallet (e.g., the payee wallet 302) and/or the payee node 310 can store a reference string (e.g., a secret) known by the payee node 310, on which the public/private key pair may be based. For example, a secret can include a string of text or alphanumeric characters, such as a password. A reference string can be generated based on words in a dictionary or database and subsequently associated with the payee node 310, the payee wallet 302 or the associated payee itself. For example, a secret can include a password that, if provided, can provide access to the payee wallet 302 if the payee loses access to this wallet. Furthermore, the secret can ensure that only those in possession of the secret can access tokens associated with the given wallet. However, as the secret can be stored off-ledger (e.g., within the payee device 250), other entities do not have access to the secret unless shared by the associated wallet. As such, the secret improves the security of the system by restricting access to a given wallet by unauthorized entities, while enabling authorized entities to recover access to the wallet in case of loss of access to the device (e.g., if the payee device 250 is physically lost or stolen).

The payment system can generate a communication request. A communication request may include a request for completion of a communication, such as a transaction. For example, in some embodiments, the payment system can generate a request for tokens of a given value at a device associated with the merchant, such as the payee device 250 associated with the payee wallet 302 (e.g., a token store 256). For example, the merchant (e.g., payee 232) can generate a transaction request, such as a QR code, indicating a monetary amount for payment in exchange for goods and services. The transaction request can include communication/transaction metadata 306, including information a relating to the purchase (e.g., purchase/communication/transaction value, timestamp of the request, identifiers or an address of the merchant's vnode or identifiers of the purchased items). For example, the transaction value can include a monetary value associated with the items desired to be purchased by a customer, such as in units of fiat currency or cryptographic currencies (e.g., cryptocurrencies). Additionally or alternatively, the transaction metadata includes a representation or indication of the public key (e.g., referred to as a communication key or a transaction key) generated based on the transaction/communication-specific nonce (or cryptographic hash thereof). In some implementations, the transaction metadata directly indicates the nonce or the hash of the nonce associated with the given transaction.

In some implementations, the payment system can generate multiple types of keys for generation within the communication request. For example, the transaction request can include a QR code with an indication of a long-lived key and/or an anonymized public key. Alternatively or additionally, the transaction request can include a transaction-specific key (e.g., the transaction key or communication key described herein).

The payer wallet 304 (e.g., as associated with the payer device 260) can compile and transmit information relating to the communication (e.g., transaction) to a node (e.g., a virtual node) corresponding to the payer wallet 304. For example, the payer wallet 304 can receive the communication metadata (e.g., the purchase or transaction metadata, as generated by the payee wallet 302). Based on receipt of the transaction metadata, the payer wallet 304 can, with or without payer input, select input tokens for generation of the transaction. As an illustrative example, the token selection can include a list of state references (e.g., State references) associated with tokens that are unspent and associated with the payer wallet 304. For example, a state reference can include a nonce or a hash of a nonce used to generate the token. For example, the state reference can include the nonce that was used to generate a key (e.g., a private key and associated public key) specific to the token indicating ownership of this token. A particular token can be associated with its own state reference (e.g., and corresponding nonce and public/private key pair). The payer wallet 304 can (e.g., through the key generator 264 associated with the payee device 260) can generate a nonce for the transaction. In one embodiment, the nonce is combined with a secret associated with the payer wallet 304. The payer wallet 304 can generate the nonce by combining a counter value (e.g., a value that increments by one when a nonce is generated) with a timestamp at generation of the nonce. The payee wallet 304 can utilize an atomic increasing hardware counter for generation of the nonce. Additionally or alternatively, the payment system can generate the nonce using pre-existing identifiers, inputs, or attributes associated with the transaction, such as a timestamp associated with the transaction or a transaction identifier.

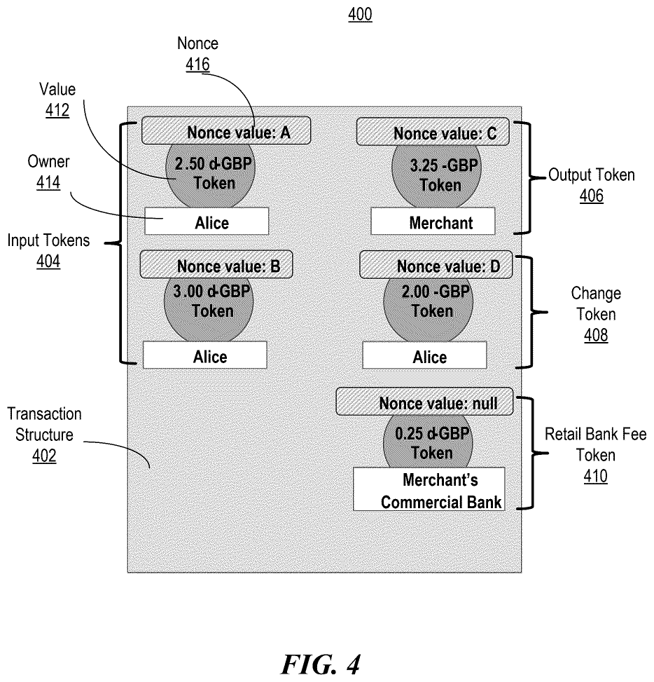

As described further in relation to FIG. 4, these selected tokens (e.g., referred to as input tokens, communication tokens, or payment tokens) may be subsequently utilized to build and execute the transaction for satisfaction of the associated contract. The payer wallet 304 can select the input tokens such that token values associated with these input tokens have a sum greater than or equal to the transaction value (e.g., the value of the goods and services being purchased from the merchant). For example, the payer wallet 304 can select these input tokens from a token database, which may include a list of unspent tokens associated with the payer wallet 304. For the input tokens associated with the nonce, the payer wallet 304 can regenerate the corresponding private key associated with the token's public/private key pair that is specific to the token. The payer wallet 304 can subsequently sign (e.g., generate digital signatures 312 for) a particular token's state reference (e.g., a hash of the corresponding nonce) based on the corresponding regenerated private key and transmit these signed state reference to the payer node 308 for generation of the transaction. For example, the digital signature can include a value based on a DSA based on the corresponding private key. As such, public/private key pairs do not need to be stored unless the corresponding private key is to be utilized for the given transaction, thereby improving the scalability of the system.

For example, the payer wallet 304 can transmit to the payer node 308, a transaction message that includes transaction metadata. Such transaction metadata can include the digital signatures of the input tokens selected for the transaction by the payer wallet 304, as well as the state reference (e.g., associated hashes of nonces) of these input tokens themselves. Furthermore, the payer node 308 can receive other information relating to the communication or transaction, such as the merchant's public key (e.g., the transaction or communication key, as described previously), the associated nonce, the wallet identifier (e.g., an identifier of the token storage corresponding to the payee wallet 302 in payee device 250), the transaction/communication value, and/or an address associated with the merchant node (e.g., the payee node 310). By doing so, the anonymous payment system enables the payer node 308 to generate the transaction for transfer of control of the value of the tokens to the merchant and subsequent validation of the transaction.

The payer node 308, for a signature corresponding to a particular corresponding input token, can determine a deterministic state (e.g., a deterministic hash or another cryptographic function of the signature). The payer node 308 can include this deterministic state in a ledger associated with the node, as well as within the built transaction, as described below.

FIG. 4 is a diagram that includes an illustration 400 of input and output communication tokens, as well as associated communication values, in accordance with one or more embodiments. For example, based on the transaction metadata (including the digital signatures 312) received from the payer wallet 304, the payer node 308 can generate a transaction structure 402 (e.g., a communication structure), where the transaction structure includes information relating to tokens being spent by the payer (as well as the associated token values), such as the input tokens 404. The transaction structure can include information relating to tokens to be generated and for which control is provided to the payee, such as output token 406. In some embodiments, such as if the sum of values associated with the input tokens 404 exceeds the transaction value, the transaction structure can include a change token 408, where the change token 408 is controlled by the payer node 308 and/or the payer wallet 304. In some embodiments, the transaction structure can include information relating to token fees, such as a retail bank fee token 410, which can include a token associated with payment of payment infrastructure-related fees. A token can be associated with a corresponding nonce and associated public/private key pair, wherein the public/private key pair is associated with the corresponding owner of the token. The transaction structure can be constructed with a specified format, such as a byte array.

As an illustrative example, the transaction structure 402 includes an indication of the input tokens 404 selected at the payer node 308. These input tokens 404 can include state references, such as information indicating the corresponding owner (e.g., the owner 414), as well as a corresponding value 412 (e.g., a monetary value associated with the CBDC token). Furthermore, a token can include an indication of a nonce 416 (e.g., a hash of a nonce), and can be associated with the corresponding public/private key pair.

The payer node 308 can generate the transaction structure 402 to include a generated output token 406. The output token 406 can include information relating to the owner and value (e.g., corresponding to the transaction value associated with the purchased goods and services). The output token 406 can include a nonce that corresponds to the transaction key (e.g., the public key specific to the given transaction that was generated by the payee node and/or payee wallet, as described above), thereby enabling the merchant to control the output token 406 subsequently.

Moreover, the payer node 308 can generate the transaction structure 402 to include a change token 408, corresponding to a difference between the transaction value and the sum of values associated with the input tokens 404 provided for the transaction. For example, this change token 408 can be generated to be associated with the payer node 308 and/or the payer wallet 304 (e.g., by determining a corresponding nonce and public/private key pair at the payer node 308, and storing the corresponding nonce in the token database). As such, the change token 408 enables payment of tokens of arbitrary values to another entity without the need for token values to add up exactly to a desired payment amount.

In some implementations, the anonymous payment system can generate, at the payer node 308, a retail bank fee token 410. For example, the retail bank fee token 410 can include a token that represents a proportion of the transaction value that is allotted to an administrator or manager of the anonymous payment system, such as a corresponding bank. For example, the retail bank fee token 410 can include a value that is subtracted from the output token 406 (e.g., subtracted from the payment received at the merchant). Alternatively or additionally, the retail bank fee token 410 can include value that is subtracted from the change token 408 (e.g., taken from the payer directly, as is the case in situations where the merchant charges the customer extra for transactions of a certain type). Alternatively or additionally, another token (e.g., a tax token) can be generated to be controlled by a government entity associated with tax collection, thereby improving the efficiency of tax payments. In some embodiments, the fee token can be associated with a nullable nonce. In some embodiments, tokens generated to be associated with well-known identities for token issuance and redemption can be associated with nullable nonces as well.

In some implementations, the payer node 308 (and/or other nodes) can generate digital signatures off-node. For example, the payer node 308 can transmit state references (or any object) associated with input tokens to the payer wallet 304 (or a device associated therewith). The payer wallet 304 can sign the object using the corresponding key and transmit the signed object back to the payer node 308. Similarly, the payee node 310 and the payee wallet 302 can carry out a similar routine for generating signed objects. In some embodiments, the off-node signing capabilities can be implemented with an application programming interface (API) and a callback.

In some embodiments, the payer wallet 304 can execute the transaction structure built at the payer node 308. For example, the payer node 308 can generate the transaction structure in the form of a byte array and transmit the transaction structure to the payer wallet 304. In some embodiments, the payer wallet 304 can identify values of interest within the transaction structure and extract these values. For example, the payer wallet 304 computes the root of the Merkle tree of the transaction by identifying positions of component groups of the byte array.

In some implementations, the payer wallet 304 generates the transaction structure (e.g., instead of or in addition to the payer node 308). For example, the payer wallet 304 can generate the byte array corresponding to the transaction structure and populate leaves of an associated Merkle tree. The payer wallet 304 can subsequently compute the root of the Merkle tree corresponding to the transaction identifier (e.g., the transaction key or a representation thereof). The payer wallet 304 can sign the root of the Merkle tree using a corresponding key, and transmit the signature and byte array back to the payer node 308 for further execution and processing of the transaction. In some embodiments, the payee node 310 and the payee wallet 302 execute similar processes (as in the case for a refund from the merchant to a customer). By generating the transaction at the wallet based on information from the node, the payment system disclosed herein improves robustness and security against man-in-the-middle attacks.

In some implementations, the wallet can build an object describing the transaction and transmit this object to the node for generation of the transaction structure. For example, the payer wallet 304 can generate an object that is able to be serialized and sent to the node. The payer wallet 304 can display the transaction structure on a mobile application associated with the payer (e.g., through the user interface 262 of the payer device 260 shown in FIG. 2). The user (e.g., the payer or customer) can sign the object through the wallet using a corresponding cryptographic key and transmit this object to the node, where the node can generate the transaction structure to include the transaction described by the object. For example, a contract code associated with the payer node 308 can process the object and determine that the transaction matches the object for authentication of the transaction. The payer node 308 can transmit this generated transaction structure back to the wallet for signing (e.g., signing the individual state references associated with the input tokens) prior to transmission to the payee node 310.

In some embodiments, the nodes (e.g., the payer node 308 or the payee node 310 shown in FIG. 3) can be managed by an auditor or another external third party (or a bank system managing the nodes). For example, an auditor node can generate a description of contract code in plain, easily understandable human language. An auditor node can audit any mobile applications associated with the wallets (and related devices).

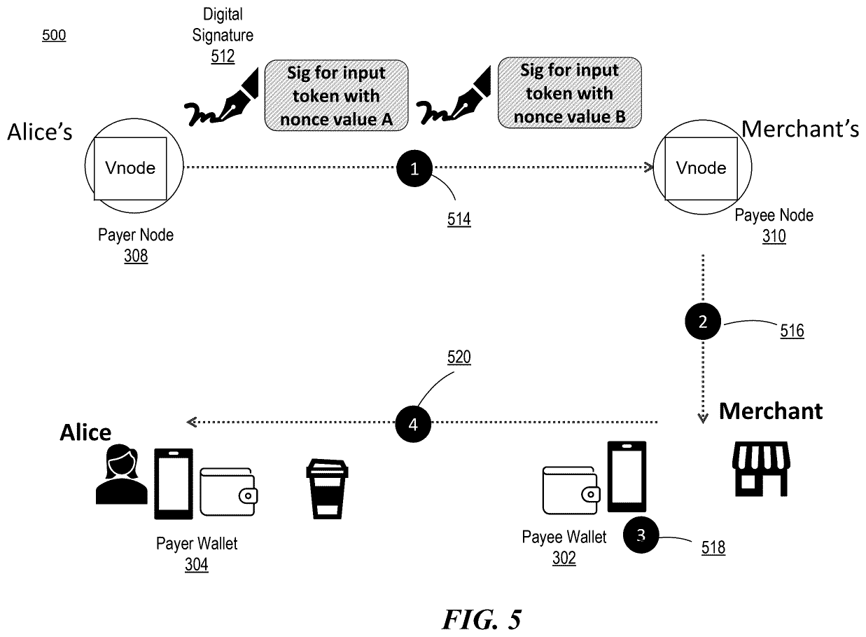

FIG. 5 is a diagram of a schematic 500 that illustrates communication validation on the basis of the verification of digital signatures, in accordance with one or more embodiments. For example, the payment system enables the payer node 308 to generate the transaction structure to include this information relating to the tokens. The transaction structure can include the deterministic states associated with the digital signatures 512 of the input tokens as input into the transaction, as well as the corresponding input tokens (e.g., the corresponding state references). The transaction structure can include the output token, as well as the associated nonce (e.g., the nonce associated with the transaction key generated by the merchant, such that the output token can be controlled directly by the merchant with knowledge of the private key corresponding to the transaction key).

For example, a contract code associated with the transaction can verify that the signature over one or more state references, as well as the output token's corresponding public key associated with the nonce, matches the owner of the corresponding token. Furthermore, the payer node 308 can generate the state reference of the output state, as well as the wallet identifier associated with the payer wallet, to an off-ledger database table on the merchant's node, thereby enabling look-up of the transaction history at the merchant's point-of-sale system.

At operation 514, the payer node 308 can transmit this transaction structure to the payee node 310. For example, the payer node 308 can transmit the transaction structure 402 to the payee node 310, including digital signatures, as described above. At operation 516, the payee node 310 can digitally sign the public key associated with the specific transaction (e.g., the communication key or the transaction key) to the merchant wallet (e.g., the payee wallet 302 associated with the payee device 250), as well as the corresponding output token's state reference (e.g., the nonce). The payee node 310 can transmit the signed public key and output token's state reference to the payee wallet 302 for further verification.

In some implementations, the payee wallet 302 can generate a first verification that indicates, for a payment token, that the corresponding digital signature is associated with a corresponding public key (e.g., as associated with the payee). Additionally or alternatively, the payee wallet 302 can match the public key associated with the transaction with that received from the payee node 310. For example, the payee wallet 302, through the payee device 250, generates a signed version of the originally generated nonce corresponding to the transaction and matches this signed version with the signature received from the payee node. By doing so, the payee device 250 can generate the second verification, which can include an indication that the transaction key corresponds to the transaction private key.

At operation 518, the payee device 250 can display (e.g., through the user interface 252) a verification message, where the verification message indicates that the transaction has been verified (e.g., through verification of the digital signatures of the input tokens, and/or the digitally signed output token state references). As such, the merchant, at operation 520, can provide the customer (e.g., the payer associated with the payer wallet 304) with the requested goods, such as a cup of coffee.

In some implementations, the anonymous payment system disclosed herein can implement various flows. For example, the anonymous payment system can utilize a “create wallet” flow, wherein a wallet can trigger a process that generates a wallet identifier on a database table within a corresponding node. The wallet identifiers can be stored off-ledger to prevent privacy leaks.

In some implementations, the anonymous payment system can issue retail tokens to the wallet. For example, a user (e.g., a customer) can exchange fiat money issued by a government authority for tokens (as described herein) using a wallet associated with a corresponding user device. For example, a commercial bank operating a node on the payment system can sign the issuance transaction as a current owner of the tokens. The payment system can contact the wallet and provide a key associated with the new owner of the state. In some implementations, the anonymous payment system can move tokens from one wallet to another wallet, using processes, algorithms, and flows described herein.

In some implementations, the anonymous payment system can provide fiat money in exchange for tokens in a redemption transaction. For example, a user can exchange tokens for fiat money (e.g., as issued by a government authority) using their wallet associated with a mobile device. For example, the wallet can sign the redemption transaction as a current owner of the tokens and move these tokens to the commercial bank in exchange for fiat money for the user.

In some implementations, the anonymous payment system described herein enables migration of a wallet from an association with a first node to a second node. For example, the payment system can utilize an indication of the wallet identifier, unspent tokens, corresponding nonces associated with an unspent token, and an associated backchain (e.g., a value or data structure encapsulating previous transactions) to migrate a wallet from a first node to a second node (e.g., from a node managed by a first bank to a node managed by a second bank). Once these elements are migrated to another node, the backchain can be archived on the original node (e.g., the node managed by the first bank), thereby freeing up memory on the node.

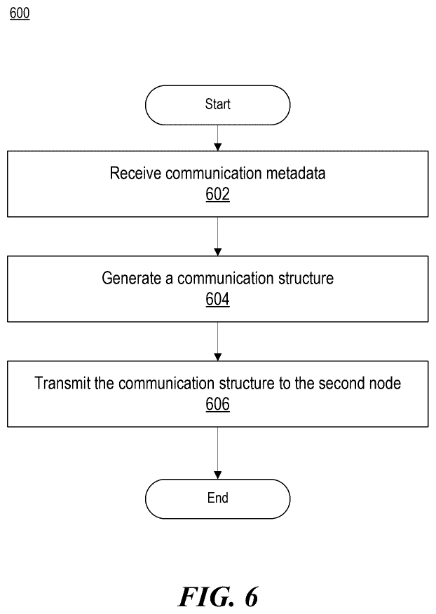

FIG. 6 is a flowchart 600 that describes generation of a communication structure for execution of a communication, in accordance with one or more embodiments. For example, flowchart 600 enables the payment system to generate a transaction structure indicating information relating to a purchase of goods and services using tokens. Furthermore, flowchart 600 enables execution of contract code associated with the transaction for further verification and execution of a transfer of funds represented by tokens.

At operation 602 (e.g., using one or more components described above), the payment system can receive communication metadata, such as information associated with transactions initiated by a customer or a merchant. For example, a node of the payment system (e.g., the payer node 308) can receive communication metadata associated with a communication and a token selection from a first device at a first node. The transaction communication metadata can include a communication value, an identifier of a token storage associated with a second entity, a communication key associated with the communication, and an address of a second node. The token selection can include a first indication of communication tokens. The first indication of communication tokens can include, for a communication token, a corresponding nonce, a corresponding private key generated using the corresponding nonce, and a corresponding digital signature based on the corresponding private key. A sum of values associated with the communication tokens may be determined to be greater than the communication value.

As an illustrative example, the node can receive information relating to a transaction, including a transaction identifier (e.g., a nonce) associated with a public key (e.g., a transaction key), thereby providing a secure reference value for the transaction. Further, the node can receive a selection of tokens with which a customer would like to execute the transaction (e.g., purchase a good or a service), where the selection of tokens has a value greater than the value of the goods or services requested by a corresponding merchant. As such, the payment system can generate output tokens for conferral to the merchant based on generating the transaction and further validation, as described herein.

In some implementations, the communication key (e.g., the transaction key) can include a public key generated at the merchant based on a nonce and/or a secret. For example, the communication key can include a public key of a public/private key pair generated using a communication nonce and a reference string at the second node (e.g., a merchant node or a payee node or, in some embodiments, at a corresponding device). The reference string can include an alphanumeric password determined by the second entity at a second device associated with the second entity. As an illustrative example, a merchant associated with a transaction with a customer (e.g., an exchange of goods or services for financial resources, such as CBDC tokens) can generate a transaction-specific public/private key based on a nonce and a secret known to the merchant. As such, the payment system enables creation of an identifier and validation method for the transaction to facilitate verification of the transaction, while maintaining the anonymity of the associated parties to the transaction.

At operation 604 (e.g., using one or more components described above), the payment system can generate a communication structure (e.g., a transaction structure) based on the received metadata. For example, the node can generate a communication structure for the communication, wherein the communication structure includes the first indication of the communication tokens and a second indication of output tokens, where an indication of at least one token of the output tokens includes a representation of the communication key. As an illustrative example, the node can generate a transaction to include output tokens for payment to the merchant from the customer, as well as tokens representing change (if the input tokens, or “communication tokens,” add up to a value different from the requested price), and/or fees associated with the transaction, such as taxes or infrastructure use fees. A communication token represented within the communication structure can be digitally signed using a corresponding private key at the payer node. The output token can be associated with the communication key (e.g., a key generated at a merchant/payee device or merchant/payer node). As such, the output token may be subsequently verified to match the transaction. By generating the transaction as such, the payment system enables instantaneous verification and transfer of funds in response to a transaction. Moreover, the use of a transaction-specific communication key (e.g., a transaction key, or a public key generated by the merchant) enables the system to preserve the anonymity of any participating entities. In some embodiments, the first node can generate the transaction structure according to a contract code.

In some implementations, the payment system can generate the communication structure to include signatures corresponding to input tokens, where the input tokens are inputs to the requested transaction. For example, a node can identify, based on the first indication of communication tokens, a set of nonces corresponding to a set of communication tokens. The node can generate a set of public/private key pairs corresponding to the set of communication tokens, wherein a public/private key pair of the set of public/private key pairs is generated based on a corresponding nonce of the set of nonces. The node can generate a signature for each communication token of the set of communication tokens. As an illustrative example, the node can utilize a nonce associated with the initial creation or receipt of an unspent token associated with the payer (e.g., as indicated within the payer wallet 304) and generate a public/private key pair based on this nonce for each token selected to be spent in the current transaction. Based on the private key associated with the given token, the payment system can sign the token for further verification that the input token (e.g., the communication token or transaction token) is indeed owned by the claimed owner.

In some implementations, the communication structure (e.g., the transaction structure) can include a token that includes the representation of the communication key. For example, a node of the payment system can generate the second indication of output tokens, where the second indication includes a set of values corresponding to the output tokens. In some implementations, the sum of the set of values is greater than the communication value (e.g., is determined/generated such that this is true). The node can generate the representation of the communication key for the first output token to include a key of the public/private key pair. For example, the payment system can generate the output token to include or be associated with the nonce used to generate the public/private key pair that is specific to the transaction at hand. Because, in some implementations, the merchant device or node (e.g., the second node or the second entity) generated the public/private key pair originally, by conferring the associated nonce to the output token, the payment system enables the merchant device or node (e.g., the payee node) to receive and assume control of the token. However, since the public/private key pair is specific to the transaction, the payment system maintains the anonymity of both the merchant and the customer (e.g., the payer).

In some implementations, the communication structure (e.g., the transaction structure) can include multiple output tokens, including a communication token (e.g., a payment token) for the merchant, a change token (e.g., for any change in the transaction for return to the payer), and one or more fee tokens (e.g., for fees or tax payments). For example, a node can generate a communication token, a change token, and a fee token, where the communication token is the first output token and is associated with a first value. The change token is associated with a second value. The fee token is associated with a third value, where the third value can be a pre-determined fraction of the communication value. The payment system can determine that a sum of the first value, the second value, and the third value corresponds to the communication value. As an illustrative example, the payment system can utilize the input tokens (e.g., communication tokens selected by a customer or other payer) to generate output tokens, some of which may be used for payment of the merchant, used for fee or tax payments, and/or returned to the user (e.g., in situations where the value of the input tokens exceeds the value of the purchase). By doing so, the payment system can confer tokens and the corresponding monetary value to the intended recipients.

At operation 606 (e.g., using one or more components described above), the payment system can cause the communication structure to be transmitted to the second node. For example, the first node can, using the address of the second node, transmit the communication structure to the second node, wherein the second node is configured to generate an output signature based on the representation of the communication key. The second node can be configured to transmit the output signature to the token storage associated with the second entity for validation of the communication based on verification of the output signature. For example, a payer node can transmit the transaction structure to a payee node for further verification of the transaction according to rules or verification procedures specified in a contract code. As an illustrative example, the payer node can verify that the output signature (corresponding to the output token) is indeed representative of a previously generated communication/transaction key associated with this specific transaction. Furthermore, the payer node can transmit the output signature and/or information relating to the output token to another entity (e.g., a payer device) for further verification and/or validation of the signature.

In some implementations, the payment system can store tokens associated with devices within a token database (e.g., off-ledger), where a token of the list of tokens includes a corresponding public/private key pair generated using an associated nonce. Once a token is spent, the payment system can indicate that this token is unavailable for further use. For example, a node associated with the payment system can store, in a token database associated with the first node, a list of tokens associated with the first device, where a token of the list of tokens includes a corresponding public/private key pair generated using an associated nonce. The payment system can update the list of tokens to indicate that the communication tokens corresponding to the token selection are unavailable. By doing so, the system can ensure that tokens, once used within a transaction, are unavailable, thereby preserving the limited supply of financial resources or currencies.

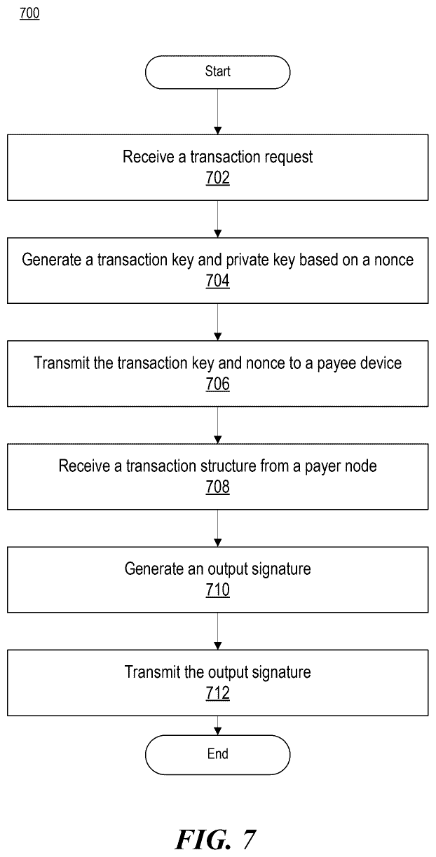

FIG. 7 is a flowchart 700 that describes communication key creation and subsequent communication validation, in accordance with one or more embodiments. For example, the flowchart 700 enables a merchant node (e.g., the payee node 230 in FIG. 2 or the payee node 310 in FIG. 3 and/or an associated device) to generate requests for payment for goods and services. Furthermore, the flowchart 700 enables the merchant to validate a transaction once it has been generated and processed by the customer.

At operation 702 (e.g., using one or more components described above), the payment system can receive a communication request (e.g., a transaction request). For example, a node (e.g., a payee node) can receive a transaction request that includes a transaction value associated with a transaction. As an illustrative example, a merchant can receive a request for a cup of coffee at a coffee shop from a customer; the merchant can input the price of the coffee (e.g., through selection of the item within a user interface in a point-of-sale system). The point-of-sale system (e.g., a payee device) can transmit this request to the payee node with data associated with the transaction, including a value of the purchase (e.g., a price of the cup of coffee), and any other fees or taxes to charge the customer. In some embodiments, the payee node can receive further information, including timestamps of the purchase and/or a list of items purchased. By receiving such information, the payment system enables generation of transaction-specific security features for settlement of the transaction.

At operation 704 (e.g., using one or more components described above), the payment system can generate a transaction key (e.g., a public/private key pair) based on the transaction to serve as an identifier and security feature for the transaction. For example, the payee node and/or an associated payee device can, in response to the transaction request, generate a transaction key and a transaction private key of a public/private key pair. The transaction key can be generated based on a first nonce associated with the transaction request. As an illustrative example, the payment system can generate the transaction key to include a public/private key pair corresponding to a hash of the generated nonce; this public key can be used as a reference for the transaction as well as a transaction-specific identifier for the output token used to pay the merchant, while keeping the identity of the merchant anonymous.

At operation 706 (e.g., using one or more components described above), the payment system can transmit the transaction key and nonce to a payee device associated with the payee node. As an illustrative example, the node associated with the merchant can transmit the transaction key (e.g., public key) associated with the specific transaction to the corresponding point-of-sale device to enable payment by the customer using the methods described herein. By doing so, the payment system leverages the public key as a method for ensuring payment of tokens to the merchant, without divulging the identity of the merchant on a corresponding ledger.

At operation 708 (e.g., using one or more components described above), the payee node or another device of the payment system can receive a transaction structure from a payer node. For example, the node can receive a transaction structure that includes a first indication of payment tokens and a second indication of output tokens. The first indication of payment tokens can include, for a payment token, a corresponding nonce and a corresponding digital signature based on the corresponding private key. An indication of at least one token of the output tokens can include a representation of the transaction key (e.g., as generated at operation 706). As an illustrative example, the payee node receives a transaction built at the payer (e.g., the payer device and/or the payer node), where the transaction includes signed representations of input tokens previously owned by the payer that have been spent during creation of output tokens (e.g., for payment of the merchant). Furthermore, the transaction can include indications of the corresponding output tokens, where the output token intended for payment to the merchant indicates the transaction key (or a representation thereof, such as the nonce used to generate the key), which can serve as an identifier of the transaction. By receiving such information, the payee node can verify that payment has been received in the form of the output tokens.

In some implementations, the transaction structure may include additional data associated with the payment and output tokens. This data can include timestamps indicating when the tokens were created or when they are set to expire. The transaction structure can also include additional information related to the payer and payee, such as public keys and/or digital certificates. The transaction structure can be encrypted before being transmitted from the payer node to the payee node, and then decrypted by the payee node upon receiving the encrypted transaction structure. Verification of the transaction at the payee node can include verification of the digital signatures associated with the payment tokens and checking of the nonces associated with the payment to ensure that they are unique and have not been reused in previous transactions. The payee node may also be used to validate the output tokens by verifying the transaction key and checking that the output token matches the expected value.

At operation 710 (e.g., using one or more components described above), the payment system (e.g., at the payee node) can generate an output signature for the transaction for further verification and validation. For example, the payment system can generate an output signature based on the representation of the transaction key. As an illustrative example, the payee node can utilize the private key associated with the transaction key (e.g., as generated at operation 704) to generate the signed version of the transaction, associated nonce, or other information associated with the transaction. By doing so, the payment system enables the payee wallet (e.g., the merchant's point-of-sale system) to verify completion of the transaction based on the received information from the payee node. In some embodiments, the output signature may also include additional data associated with the transaction. This data can include information relating to when the transaction was initiated and/or completed and information about the payer and/or payee.

At operation 712 (e.g., using one or more components described above), the payment system can transmit the output signature to the payee device (e.g., a point-of-sale system) for further verification. Based on receiving this information, the payee device can be configured to generate a first verification and a second verification, as well as display a verification message to the customer and/or merchant accordingly. For example, the payee node can transmit the output signature to a payee wallet associated with the payee device for validation of the transaction based on verification of the output signature. The payee device can generate a first verification, wherein the first verification includes an indication that, for a payment token, the corresponding digital signature is associated with a corresponding public key. The payee device can generate a second verification, where the second verification includes an indication that the transaction key corresponds to the transaction private key. Based on the first verification and the second verification, the payee device can generate a verification message for display on a user interface associated with the payee device. As an illustrative example, the payee device can carry out any validations according to a contract code associated with the transaction, including a check as to the validity of the output signature generated at the payee node and whether the transaction data matches this signature. Furthermore, the payee device can display information relating to the verification to a merchant and/or a customer to validate and settle the transaction. As such, the payment system disclosed herein enables instantaneous validation and settlement of transactions, while hiding the identities of the corresponding entities involved.

### EXAMPLES

Example 1. Disclosed herein is a method for facilitating secure communications with confidential entities, the method comprising: receiving communication metadata associated with a communication and a token selection from a first device at a first node, wherein the communication metadata comprises a communication value, an identifier of a token storage associated with a second entity, a communication key associated with the communication, and an address of a second node, wherein the token selection comprises a first indication of communication tokens, wherein the first indication of communication tokens includes, for a communication token, a corresponding nonce, a corresponding private key generated using the corresponding nonce, and a corresponding digital signature based on the corresponding private key, and wherein a sum of values associated with the communication tokens is greater than the communication value; generating a communication structure for the communication, the communication structure comprising the first indication of communication tokens and a second indication of output tokens, wherein an indication of at least one token of the output tokens includes a representation of the communication key; and using the address of the second node, transmitting the communication structure to the second node, wherein the second node is configured to: generate an output signature based on the representation of the communication key; and transmit the output signature to the token storage associated with the second entity for validation of the communication based on verification of the output signature.

Example 2. Also disclosed is the method of Example 1, wherein generating the communication structure comprises: identifying, based on the first indication of communication tokens, a set of nonces corresponding to a set of communication tokens; generating a set of public/private key pairs corresponding to the set of communication tokens, wherein a public/private key pair of the set of public/private key pairs is generated based on a corresponding nonce of the set of nonces; and generating a signature for at least one communication token of the set of communication tokens.

Example 3. Also disclosed is the method of Example 1, further comprising: storing, in a token database associated with the first node, a list of tokens associated with the first device, wherein a token of the list of tokens comprises a corresponding public/private key pair generated using an associated nonce; and updating the list of tokens to indicate that the communication tokens corresponding to the token selection are unavailable.

Example 4. Also disclosed is the method of Example 1, wherein the communication key comprises a public key of a public/private key pair generated using a communication nonce and a reference string at the second node, and wherein the reference string includes an alphanumeric password determined by the second entity at a second device associated with the second entity.

Example 5. Also disclosed is the method of Example 4, wherein generating the communication structure comprises: generating the second indication of output tokens, wherein the second indication comprises a set of values corresponding to the output tokens, and wherein a sum of the set of values is greater than the communication value; and generating the representation of the communication key for a first output token to include a key of the public/private key pair.

Example 6. Also disclosed is the method of Example 5, wherein generating the communication structure comprises: generating a communication token, a change token, and a fee token, wherein the communication token is the first output token and is associated with a first value, wherein the change token is associated with a second value, wherein the fee token is associated with a third value, and wherein the third value is a pre-determined fraction of the communication value; and determining that a sum of the first value, the second value, and the third value corresponds to the communication value.

Example 7. Disclosed is a system for conducting a transaction using a central bank digital currency (CBDC), the system comprising: at least one hardware processor; and at least one non-transitory memory storing instructions that, when executed by the at least one hardware processor, cause the system to: receive transaction metadata and a token selection from a payer device at a payer node, wherein the transaction metadata comprises a transaction value, an identifier of a payee wallet associated with a payee device, a transaction key associated with the transaction, and an address of a payee node, wherein the token selection comprises a first indication of payment tokens and digital signatures corresponding to the payment tokens, wherein the first indication of payment tokens includes, for a payment token, a corresponding nonce, a corresponding private key generated using the corresponding nonce, and a corresponding digital signature based on the corresponding private key, and wherein a sum of values associated with the payment tokens is greater than the transaction value; generate a transaction structure for the transaction, the transaction structure comprising the first indication of payment tokens and a second indication of output tokens, wherein an indication of at least one token of the output tokens includes a representation of the transaction key; and using the address of the payee node, transmit the transaction structure to the payee node, wherein the payee node is configured to: generate an output signature based on the representation of the transaction key; and transmit the output signature to the payee wallet associated with the identifier of the payee wallet for validation of the transaction based on verification of the output signature.

Example 8. Also disclosed is the system of Example 7, wherein the instructions for generating the transaction structure cause the system to: identify, based on the first indication of payment tokens, a set of nonces corresponding to a set of payment tokens; generate a set of public/private key pairs corresponding to the set of payment tokens, wherein a public/private key pair of the set of public/private key pairs is generated based on a corresponding nonce of the set of nonces; and generate a signature for at least one payment token of the set of payment tokens.

Example 9. Also disclosed is the system of Example 7, wherein the instructions cause the system to: store, in a token database associated with the payer node, a list of tokens associated with the payer device, wherein a token of the list of tokens comprises a corresponding public/private key pair generated using an associated nonce; and update the list of tokens to indicate that the payment tokens corresponding to the token selection are unavailable.

Example 10. Also disclosed is the system of Example 7, wherein the transaction key comprises a public key of a public/private key pair generated using a transaction nonce and a reference string at the payee node, and wherein the reference string includes an alphanumeric password determined by a payee at the payee device.

Example 11. Also disclosed is the system of Example 10, wherein the instructions for generating the transaction structure cause the system to: generate the second indication of output tokens, wherein the second indication comprises a set of values corresponding to the output tokens, and wherein a sum of the set of values is greater than the transaction value; and generate the representation of the transaction key for a first output token to include a key of the public/private key pair.

Example 12. Also disclosed is the system of Example 11, wherein the instructions for generating the transaction structure cause the system to: generate a purchase token, a change token, and a fee token, wherein the purchase token is the first output token and is associated with a first value, wherein the change token is associated with a second value, wherein the fee token is associated with a third value, and wherein the third value is a pre-determined fraction of the transaction value; and determine that a sum of the first value, the second value, and the third value corresponds to the transaction value.

Example 13. Disclosed is one or more non-transitory, computer-readable storage media comprising instructions recorded thereon that, when executed by at least one processor of a system, cause the system to: receive, at a payee node, a transaction request comprising a transaction value associated with a transaction; in response to the transaction request, generate a transaction key and a transaction private key of a public/private key pair, wherein the transaction key is generated based on a first nonce associated with the transaction request; transmit the transaction key and the first nonce to a payee device associated with the payee node; receive, from a payer node, a transaction structure, wherein the transaction structure comprises a first indication of payment tokens and a second indication of output tokens, wherein the first indication of payment tokens includes, for a payment token, a corresponding nonce, a corresponding private key generated based on the corresponding nonce, and a corresponding digital signature is associated with a corresponding public key; generate a second verification, wherein the second verification comprises an indication that the transaction key corresponds to the transaction private key; and based on the first verification and the second verification, generate a verification message for display on a user interface associated with the payee device.

Example 14. Also disclosed is one or more non-transitory, computer-readable storage media of Example 13, wherein the instructions further cause the system to: store, in a token database associated with the payer node, a list of tokens associated with a payer device, wherein a token of the list of tokens comprises a corresponding public/private key pair generated using an associated nonce; and update the list of tokens to indicate that the payment tokens corresponding to the first indication of payment tokens are unavailable.

Example 15. Also disclosed is one or more non-transitory, computer-readable storage media of Example 13, wherein the transaction key comprises a public key of a public/private key pair generated using a transaction nonce and a reference string at the payee node.

Example 16. Also disclosed is one or more non-transitory, computer-readable storage media of Example 15, wherein the instructions further cause the system to: generate the second indication of output tokens, wherein the second indication comprises a set of values corresponding to the output tokens, and wherein a sum of the set of values is greater than the transaction value; and generate the representation of the transaction key for a first input token to include a key of public/private key pair.

Example 17. Also disclosed is one or more non-transitory, computer-readable storage media of Example 16, wherein the instructions further cause the system to: generate a purchase token, a change token, and a fee token, wherein the purchase token is the first output token and is associated with a first value, wherein the change token is associated with a second value, wherein the fee token is associated with a third value, and wherein the third value is a pre-determined fraction of the transaction value; and verify that a sum of the first value, the second value, and the third value corresponds to the transaction value.

Example 18. Also disclosed is one or more non-transitory, computer-readable storage media of Example 13, wherein the instructions further cause the system to: carry out any validations according to a contract code associated with the transaction, including a check as to the validity of the output signature generated at the payee node and whether transaction data pertaining to the transaction matches this signature.

Example 19. Also disclosed is one or more non-transitory, computer-readable storage media of Example 13, wherein the transaction structure further comprises a reference to a token state for at least one payment token, wherein the token state includes a nonce and a corresponding public/private key pair generated using the nonce, and wherein future use of the token relates to verification of the token state.

Example 20. Also disclosed is one or more non-transitory, computer-readable storage media of Example 19, wherein the token state reference includes a representation of the transaction key, and wherein the representation is used to generate an output signature for validation of the transaction.

### Remarks

The terms “example,” “embodiment,” and “implementation” are used interchangeably. For example, references to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A method for facilitating secure communications with confidential entities, the method comprising:
receiving communication metadata associated with a communication and a token selection from a first device at a first node,
wherein the communication metadata comprises a communication value, an identifier of a token storage associated with a second entity, a communication key associated with the communication, and an address of a second node,
wherein the token selection comprises a first indication of communication tokens,
wherein the first indication of communication tokens includes, for a particular communication token, a corresponding nonce, a corresponding private key generated using the corresponding nonce, and a corresponding digital signature based on the corresponding private key, and
wherein a sum of values associated with the communication tokens is greater than the communication value;
generating a communication structure for the communication, the communication structure comprising the first indication of communication tokens and a second indication of output tokens,
wherein an indication of at least one token of the output tokens includes a representation of the communication key; and
using the address of the second node, transmitting the communication structure to the second node, wherein the second node is configured to:
generate an output signature based on the representation of the communication key; and
transmit the output signature to the token storage associated with the second entity for validation of the communication based on verification of the output signature.

2. The method of claim 1, wherein generating the communication structure comprises:
identifying, based on the first indication of communication tokens, a set of nonces corresponding to a set of communication tokens;
generating a set of public/private key pairs corresponding to the set of communication tokens, wherein a particular public/private key pair of the set of public/private key pairs is generated based on a corresponding nonce of the set of nonces; and
generating a signature for a particular communication token of the set of communication tokens.

3. The method of claim 1, further comprising:
storing, in a token database associated with the first node, a list of tokens associated with the first device,
wherein a particular token of the list of tokens comprises a corresponding public/private key pair generated using an associated nonce; and
updating the list of tokens to indicate that the communication tokens corresponding to the token selection are unavailable.

4. The method of claim 1, wherein the communication key comprises a public key of a public/private key pair generated using a communication nonce and a reference string at the second node, and wherein the reference string includes an alphanumeric password determined by the second entity at a second device associated with the second entity.

5. The method of claim 4, wherein generating the communication structure comprises:
generating the second indication of output tokens,
wherein the second indication comprises a set of values corresponding to the output tokens, and
wherein a sum of the set of values is greater than the communication value; and
generating the representation of the communication key for a first output token to include a key of the public/private key pair.

6. The method of claim 5, wherein generating the communication structure comprises:
generating a communication token, a change token, and a fee token,
wherein the communication token is the first output token and is associated with a first value,
wherein the change token is associated with a second value,
wherein the fee token is associated with a third value, and
wherein the third value is a pre-determined fraction of the communication value; and
determining that a sum of the first value, the second value, and the third value corresponds to the communication value.

7. A system for conducting a transaction using a central bank digital currency (CBDC), the system comprising:
at least one hardware processor; and
at least one non-transitory memory storing instructions that, when executed by the at least one hardware processor, cause the system to:
receive transaction metadata and a token selection from a payer device at a payer node,
wherein the transaction metadata comprises a transaction value, an identifier of a payee wallet associated with a payee device, a transaction key associated with the transaction, and an address of a payee node,
wherein the token selection comprises a first indication of payment tokens and digital signatures corresponding to the payment tokens,
wherein the first indication of payment tokens includes, for a particular payment token, a corresponding nonce, a corresponding private key generated using the corresponding nonce, and a corresponding digital signature based on the corresponding private key, and
wherein a sum of values associated with the payment tokens is greater than the transaction value;
generate a transaction structure for the transaction, the transaction structure comprising the first indication of payment tokens and a second indication of output tokens,
wherein an indication of at least one token of the output tokens includes a representation of the transaction key; and
using the address of the payee node, transmit the transaction structure to the payee node, wherein the payee node is configured to:
generate an output signature based on the representation of the transaction key; and
transmit the output signature to the payee wallet associated with the identifier of the payee wallet for validation of the transaction based on verification of the output signature.

8. The system of claim 7, wherein the instructions for generating the transaction structure cause the system to:
identify, based on the first indication of payment tokens, a set of nonces corresponding to a set of payment tokens;
generate a set of public/private key pairs corresponding to the set of payment tokens, wherein a particular public/private key pair of the set of public/private key pairs is generated based on a corresponding nonce of the set of nonces; and
generate a signature for a particular payment token of the set of payment tokens.

9. The system of claim 7, wherein the instructions cause the system to:
store, in a token database associated with the payer node, a list of tokens associated with the payer device,
wherein a particular token of the list of tokens comprises a corresponding public/private key pair generated using an associated nonce; and
update the list of tokens to indicate that the payment tokens corresponding to the token selection are unavailable.

10. The system of claim 7, wherein the transaction key comprises a public key of a public/private key pair generated using a transaction nonce and a reference string at the payee node, and wherein the reference string includes an alphanumeric password determined by a payee at the payee device.

11. The system of claim 10, wherein the instructions for generating the transaction structure cause the system to:
generate the second indication of output tokens,
wherein the second indication comprises a set of values corresponding to the output tokens, and
wherein a sum of the set of values is greater than the transaction value; and
generate the representation of the transaction key for a first output token to include a key of the public/private key pair.

12. The system of claim 11, wherein the instructions for generating the transaction structure cause the system to:
generate a purchase token, a change token, and a fee token,
wherein the purchase token is the first output token and is associated with a first value,
wherein the change token is associated with a second value,
wherein the fee token is associated with a third value, and
wherein the third value is a pre-determined fraction of the transaction value; and
determine that a sum of the first value, the second value, and the third value corresponds to the transaction value.

13. One or more non-transitory, computer-readable storage media comprising instructions recorded thereon that, when executed by at least one processor of a system, cause the system to:
receive, at a payee node, a transaction request comprising a transaction value associated with a transaction;
in response to the transaction request, generate a transaction key and a transaction private key of a public/private key pair,
wherein the transaction key is generated based on a first nonce associated with the transaction request;
transmit the transaction key and the first nonce to a payee device associated with the payee node;
receive, from a payer node, a transaction structure,
wherein the transaction structure comprises a first indication of payment tokens and a second indication of output tokens,
wherein the first indication of payment tokens includes, for a particular payment token, a corresponding nonce, a corresponding private key generated based on the corresponding nonce, and a corresponding digital signature based on the corresponding private key, and
wherein an indication of at least one token of the output tokens includes a representation of the transaction key;
generate an output signature based on the representation of the transaction key; and
transmit the output signature to a payee wallet associated with the payee device for validation of the transaction based on verification of the output signature, wherein the payee device is configured to:
generate a first verification, wherein the first verification comprises an indication that, for a particular payment token, the corresponding digital signature is associated with a corresponding public key;
generate a second verification, wherein the second verification comprises an indication that the transaction key corresponds to the transaction private key; and
based on the first verification and the second verification, generate a verification message for display on a user interface associated with the payee device.

14. The one or more non-transitory, computer-readable storage media of claim 13, wherein the instructions further cause the system to:
store, in a token database associated with the payer node, a list of tokens associated with a payer device,
wherein a particular token of the list of tokens comprises a corresponding public/private key pair generated using an associated nonce; and
update the list of tokens to indicate that the payment tokens corresponding to the first indication of payment tokens are unavailable.

15. The one or more non-transitory, computer-readable storage media of claim 13, wherein the transaction key comprises a public key of a public/private key pair generated using a transaction nonce and a reference string at the payee node.

16. The one or more non-transitory, computer-readable storage media of claim 15, wherein the instructions further cause the system to:
generate the second indication of output tokens,
wherein the second indication comprises a set of values corresponding to the output tokens, and
wherein a sum of the set of values is greater than the transaction value; and
generate the representation of the transaction key for a first input token to include a key of public/private key pair.

17. The one or more non-transitory, computer-readable storage media of claim 16, wherein the instructions further cause the system to:
generate a purchase token, a change token, and a fee token,
wherein the purchase token is a first output token and is associated with a first value,
wherein the change token is associated with a second value, wherein the fee token is associated with a third value, and
wherein the third value is a pre-determined fraction of the transaction value; and
verify that a sum of the first value, the second value, and the third value corresponds to the transaction value.

18. The one or more non-transitory, computer-readable storage media of claim 13, wherein the instructions further cause the system to:
carry out any validations according to a contract code associated with the transaction, including a check as to validity of the output signature generated at the payee node and whether transaction data pertaining to the transaction matches this signature.

19. The one or more non-transitory, computer-readable storage media of claim 13, wherein the transaction structure further comprises a reference to a token state for a particular payment token, wherein the token state includes a nonce and a corresponding public/private key pair generated using the nonce, and wherein future use of a particular token is based on the token state.

20. The one or more non-transitory, computer-readable storage media of claim 19, wherein the reference to the token state includes a representation of the transaction key, and wherein the representation is used to generate an output signature for validation of the transaction.
